(19) United States
(12) Patent Application Publication
(10) Pub. No.: US 2025/0139651 A1
(43) Pub. Date: May 1, 2025

(54) BIOLOGICAL INFORMATION PROCESSING APPARATUS, BIOLOGICAL INFORMATION PROCESSING SYSTEM, BIOLOGICAL INFORMATION PROCESSING METHOD, AND COMPUTER-READABLE RECORDING MEDIUM

(71) Applicant: CANON MEDICAL SYSTEMS CORPORATION, Otawara-shi (JP)

(72) Inventors: Kazuki UTSUNOMIYA, Nasushiobara (JP); Atsuko SUGIYAMA, Nasushiobara (JP)

(73) Assignee: CANON MEDICAL SYSTEMS CORPORATION, Otawara-shi (JP)

(21) Appl. No.: 18/926,548

(22) Filed: Oct. 25, 2024

(30) Foreign Application Priority Data
Oct. 31, 2023 (JP) 2023-187230
Aug. 28, 2024 (JP) 2024-146957

(51) Int. Cl. G06Q 30/0201

(52) U.S. Cl. CPC G06Q 30/0206

(57) ABSTRACT

A biological information processing apparatus according to an embodiment includes an acquisition unit and a value calculation unit. The acquisition unit acquires provision biological information held by a provider and necessary information indicating biological information required by a provision destination candidate of the provision biological information. The value calculation unit acquires (calculates) a value of the provision biological information on the basis of the provision biological information and necessary information acquired by the acquisition unit.

### CROSS REFERENCE TO RELATED APPLICATIONS

This application is based upon and claims the benefit of priority from the prior Japanese Patent Applications No. 2023-187230, filed on Oct. 31, 2023, and No. 2024-146957, filed on Aug. 28, 2024, the entire contents of which are incorporated herein by reference.

### FIELD

Embodiments disclosed in the present specification and the drawings relate to a biological information processing apparatus, a biological information processing system, a biological information processing method, and a computer-readable recording medium.

### BACKGROUND

In recent years, digital twin in a medical area and a healthcare area has attracted attention, and a movement to utilize individual medical data and healthcare data has progressed. On the other hand, since there is also a movement that the medical data and the healthcare data are managed by an individual, it is assumed that the medical data and the healthcare data in an amount sufficient for utilization are not collected. Therefore, in order to promote provision of the medical data and the healthcare data, it is conceivable to impart an incentive such as medical cost deduction to a provider of the medical data and the healthcare data.

When an incentive is imparted to the provider, it is necessary to calculate a value of the medical data and the healthcare data as a reference of the incentive. For example, it is conceivable to calculate the value on the basis of profitability that a provision destination can acquire by the medical data and the healthcare data. However, even when decision making on a medical practice is made by utilizing the medical data and the healthcare data, reward for the medical practice itself, that is, profitability does not change. In addition, when determination of “not performing a medical practice” by utilizing the medical data and the healthcare data is made, profit cannot be obtained. Therefore, it is difficult to appropriately calculate the value of the medical data and the healthcare data on the basis of profitability. In addition, for example, it is conceivable to calculate the value on the basis of a compensation amount at the time of leakage of the medical data and the healthcare data. However, when the medical data and the healthcare data are provided in a state not including personal information, there is no harm even if the medical data and the healthcare data are leaked, and thus, the value is calculated to be zero. Therefore, it is difficult to appropriately calculate the value of the medical data and the healthcare data on the basis of the compensation amount at the time of leakage. In addition, for example, it is conceivable to calculate the value of the medical data on the basis of whether or not the medical data satisfies a condition regarding medical care utilizing the medical data. However, in this case, it is not possible to calculate a value of biological data whose medical value is unknown.

### BRIEF DESCRIPTION OF THE DRAWINGS

FIG. 1 is a block diagram illustrating a configuration example of a biological information processing system according to a first embodiment;

FIG. 2 is a block diagram illustrating a configuration example of a biological information processing apparatus according to the first embodiment;

FIG. 3 is a flowchart illustrating an operation example of the biological information processing apparatus according to the first embodiment;

FIG. 4 is a flowchart illustrating a step of determining a provision destination candidate in the operation example of the biological information processing apparatus according to the first embodiment;

FIG. 5 is a diagram illustrating a selection screen used in the step of determining a provision destination candidate in the operation example of the biological information processing apparatus according to the first embodiment;

FIG. 6 is a diagram illustrating an example of provision biological data acquired in a step of acquiring provision biological data in the operation example of the biological information processing apparatus according to the first embodiment;

FIG. 7 is a diagram illustrating an example of provision destination candidate data acquired in a step of acquiring provision destination candidate data in the operation example of the biological information processing apparatus according to the first embodiment;

FIG. 8 is a flowchart illustrating a step of calculating a value of provision biological data in the operation example of the biological information processing apparatus according to the first embodiment;

FIG. 9 is a diagram illustrating an example of a value acquired in the step of calculating a value of provision biological data in the operation example of the biological information processing apparatus according to the first embodiment;

FIG. 10 is a diagram illustrating an example of a presentation screen displayed in a step of presenting a value of provision biological data in the operation example of the biological information processing apparatus according to the first embodiment;

FIG. 11 is a flowchart illustrating a step of determining a provision destination candidate in an operation example of a biological information processing apparatus according to a first modification of the first embodiment;

FIG. 12 is a diagram illustrating a selection screen used in the step of determining a provision destination candidate in the operation example of the biological information processing apparatus according to the first modification of the first embodiment;

FIG. 13 is a diagram illustrating a presentation screen displayed in a step of presenting a value of provision biological data in the operation example of the biological information processing apparatus according to the first modification of the first embodiment;

FIG. 14 is a diagram illustrating provision biological data acquired in a step of acquiring provision biological data in an operation example of a biological information processing apparatus according to a second modification of the first embodiment;

FIG. 15 is a diagram illustrating provision destination candidate data acquired in a step of acquiring provision destination candidate data in the operation example of the biological information processing apparatus according to the second modification of the first embodiment;

FIG. 16 is a diagram illustrating a value acquired in the step of calculating a value of provision biological data in the operation example of the biological information processing apparatus according to the second modification of the first embodiment;

FIG. 17 is a diagram illustrating provision destination candidate data acquired in a step of acquiring provision destination candidate data in an operation example of a biological information processing apparatus according to a third modification of the first embodiment;

FIG. 18 is a flowchart illustrating a step of calculating a value of provision biological data in the operation example of the biological information processing apparatus according to the third modification of the first embodiment;

FIG. 19 is a diagram illustrating provision destination candidate data acquired in a step of acquiring provision destination candidate data in an operation example of a biological information processing apparatus according to a fourth modification of the first embodiment;

FIG. 20 is a flowchart illustrating a step of calculating a value of provision biological data in the operation example of the biological information processing apparatus according to the fourth modification of the first embodiment;

FIG. 21 is a diagram illustrating provision biological data acquired in a step of acquiring provision biological data in an operation example of a biological information processing apparatus according to a fifth modification of the first embodiment;

FIG. 22 is a diagram illustrating provision destination candidate data acquired in a step of acquiring provision destination candidate data in the operation example of the biological information processing apparatus according to the fifth modification of the first embodiment;

FIG. 23 is a diagram illustrating a value acquired in a step of calculating a value of provision biological data in the operation example of the biological information processing apparatus according to the fifth modification of the first embodiment;

FIG. 24 is a diagram illustrating provision biological data, provision destination candidate data, and a value of the provision biological data in an operation example of a biological information processing apparatus according to a sixth modification of the first embodiment;

FIG. 25 is a diagram illustrating provision biological data acquired in a step of acquiring provision biological data in an operation example of a biological information processing apparatus according to an eighth modification of the first embodiment;

FIG. 26 is a diagram illustrating provision destination candidate data acquired in a step of acquiring provision destination candidate data in the operation example of the biological information processing apparatus according to the eighth modification of the first embodiment;

FIG. 27 is a diagram illustrating an example of a value acquired in a step of calculating a value of provision biological data in the operation example of the biological information processing apparatus according to the eighth modification of the first embodiment;

FIG. 28 is a block diagram illustrating a configuration example of a biological information processing apparatus according to a second embodiment;

FIG. 29 is a flowchart illustrating an operation example of the biological information processing apparatus according to the second embodiment;

FIG. 30 is a diagram illustrating a value of provision biological data and provision possibility information presented in a step of presenting the value of the provision biological data and the provision possibility information in the operation example of the biological information processing apparatus according to the second embodiment;

FIG. 31 is a flowchart illustrating an operation example of a biological information processing apparatus according to a first modification of the second embodiment;

FIG. 32 is a diagram illustrating a value of provision biological data, provision possibility information, and provision priority information presented in a step of presenting the value of the provision biological data, the provision possibility information, and the provision priority information in the operation example of the biological information processing apparatus according to the first modification of the second embodiment;

FIG. 33 is a block diagram illustrating a configuration example of a biological information processing apparatus according to a third embodiment; and

FIG. 34 is a flowchart illustrating an operation example of the biological information processing apparatus according to the third embodiment.

### DETAILED DESCRIPTION

Hereinafter, an embodiment of a biological information processing apparatus will be described in detail with reference to the drawings. In the following description, components having substantially the same functions and configurations are denoted by the same reference numerals, and redundant description will be made only when necessary.

### First Embodiment

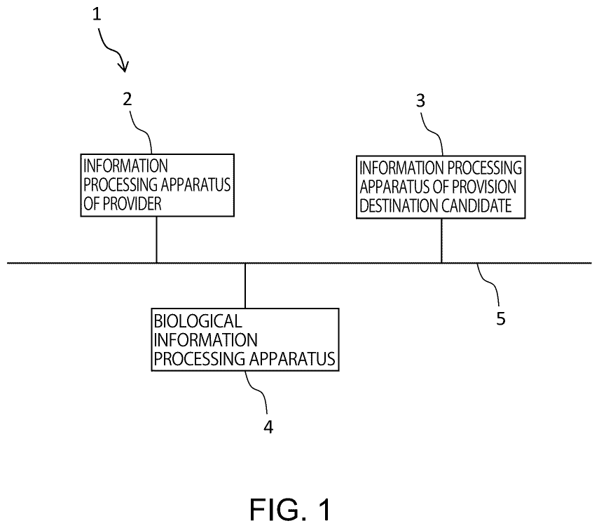

FIG. 1 is a block diagram illustrating a configuration example of a biological information processing system 1 according to a first embodiment. As illustrated in FIG. 1, the biological information processing system 1 includes an information processing apparatus 2 of a provider, an information processing apparatus 3 of a provision destination candidate, and a biological information processing apparatus 4. The biological information processing apparatus 4 is communicably connected to the information processing apparatus 2 of a provider and the information processing apparatus 3 of a provision destination candidate via a network 5 such as a local area network (LAN). The information processing apparatus 2 of a provider is an example of a first information processing apparatus. The information processing apparatus 3 of a provision destination candidate is an example of a second information processing apparatus.

The information processing apparatus 2 of a provider holds provision biological data of the provider. In the first embodiment, the provider is an individual whose provision biological data is detected by a test or the like in a medical institution. The provision biological data is biological data provided from the provider to a provision destination. The provision biological data is an example of provision biological information. The provision biological data is, for example, biological data handled in medical care or healthcare. The provision biological data may be handled in a field other than the medical care and the healthcare.

The provision biological data includes, for example, an item for classifying biological data and a value of the biological data belonging to the item (that is, a main body of data). The item included in the provision biological data is an example of a first item. The provision biological data may further include data stored in an electronic medical record or the like (for example, free text data such as medical history, SOAP: subjective information, objective information, evaluation, and planning, nursing summary, and discharge summary). Examples of the item include a personal item and a test item. The personal item may include, for example, items such as “age” and “sex”. The test item may include, for example, items such as “total protein”, “albumin (ALB)”, “AST (GOT)”, “ALT (GPT)”, “Y-GTP”, and “amylase”. A value of the biological data belonging to the item may be, for example, “32” for the item of age, “male” for the item of sex, “6.7 g/dL” for the item of total protein, “4.8 g/dL” for the item of albumin (ALB), and “19 U/L” for the item of AST (GOT). The item may further include a value acquired from a general-purpose device such as a smart watch (for example, heart rate, blood pressure, or SpO2: percutaneous arterial oxygen saturation).

The information processing apparatus 2 of a provider includes, for example, an installation type or portable type terminal device such as a personal computer (PC), a tablet terminal, or a mobile phone. The provision biological data is stored, for example, in a memory of the terminal device. The information processing apparatus 2 of a provider may further include a storage device, that is, a server communicably connected to the terminal device via the network 5. In this case, the provision biological data may be stored in the storage device.

The information processing apparatus 3 of a provision destination candidate holds necessary data indicating biological data required by the provision destination candidate of the provision biological data. The necessary data is individual for each provision destination candidate.

The provision destination candidate is, for example, a decentralized autonomous organization (DAO) related to medical care or healthcare. The provision destination candidate may be a DAO related to a research purpose other than medical care and healthcare. The DAO may be a DAO according to a research theme, such as a cardiac disease DAO, a sequelae analysis DAO, or a pancreatic cancer DAO, a DAO for the purpose of collecting data for drug discovery, a DAO for the purpose of collecting data for machine learning for extracting a disease such as cancer, or the like. In addition, the DAO may be constituted using a blockchain. In addition, the provision destination candidate is not limited to the DAO, and may be, for example, a centralized or distributed database such as a hospital information system, a national database such as National Database (NDB), or a network group for each organization such as a hospital, a medical organization, or an academic society existing on a conventional network.

The necessary data includes, for example, an item for classifying biological data required by the provision destination candidate. The item included in the necessary data is an example of a second item. The item of the necessary data includes, for example, a personal item and a test item. In this case, it means that the provision destination candidate requires biological data having any value belonging to the personal item and any value belonging to the test item. Specifically, when the necessary data includes the personal items “age” and “sex” and the test item “total protein”, it means that the provision destination candidate requires biological data including any value belonging to each of “age”, “sex”, and “total protein”. The necessary data may further include a value belonging to the item. In this case, it means that the provision destination candidate requires biological data having a concerned value (that is, a specific value) included in the necessary data.

The information processing apparatus 3 of a provision destination candidate includes, for example, a terminal device of each of persons belonging to a DAO communicably connected via the network 5. The terminal device may be either an installation type or a portable type. The necessary data is stored in, for example, a memory of a terminal device of a person belonging to a DAO. The information processing apparatus 3 of a provision destination candidate may further include a storage device, that is, a server communicably connected to a terminal device of a person belonging to a DAO via the network 5. In this case, the necessary data may be stored in the storage device.

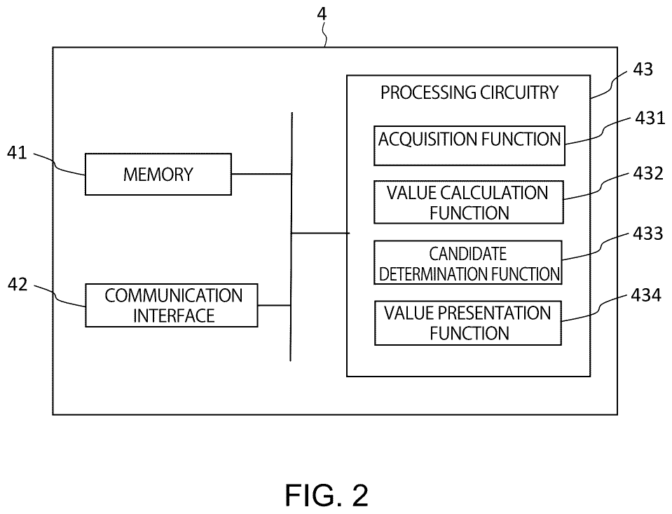

FIG. 2 is a block diagram illustrating a configuration example of the biological information processing apparatus 4 according to the first embodiment. The biological information processing apparatus 4 is an apparatus that acquires (calculates) a value of provision biological data and presents the value to a provider. As illustrated in FIG. 2, the biological information processing apparatus 4 includes a memory 41, a communication interface 42, and a processing circuitry 43.

The memory 41 is a non-transitory storage device that stores various types of information, and is, for example, a hard disk drive (HDD), an optical disk, a solid state drive (SSD), or an integrated circuit storage device. The memory 41 stores, for example, a control program for controlling the biological information processing apparatus 4 and various types of data used for executing the control program. The memory 41 may be a drive device that reads and writes various types of information from and to a portable storage medium such as a compact disc (CD), a digital versatile disc (DVD), or a flash memory, a semiconductor memory element such as a random access memory (RAM), or the like, in addition to the HDD, the SSD, and the like. Note that the memory 41 does not necessarily need to be implemented by a single storage device. For example, the memory 41 may be implemented by a plurality of storage devices.

The communication interface 42 is an interface that communicably connects the biological information processing apparatus 4 to the information processing apparatus 2 of a provider and the information processing apparatus 3 of a provision destination candidate. The communication interface 42 is constituted by, for example, a connector conforming to a parallel connection specification or a serial connection specification. For example, the communication interface 42 performs communication control according to each standard, is connected to the network 5, and thereby connects the biological information processing apparatus 4 to the information processing apparatus 2 of a provider and the information processing apparatus 3 of a provision destination candidate via the network 5.

The processing circuitry 43 is a circuitry that controls the entire operation of the biological information processing apparatus 4 according to an electrical signal of an input operation received from the information processing apparatus 2 of a provider via the communication interface 42. The processing circuitry 43 includes, for example, an acquisition function 431, a value calculation function 432, a candidate determination function 433, and a value presentation function 434. The acquisition function 431 is an example of an acquisition unit. The value calculation function 432 is an example of a value calculation unit. The candidate determination function 433 is an example of a candidate determination unit. The value presentation function 434 is an example of a value presentation unit.

Here, for example, processing functions executed by the acquisition function 431, the value calculation function 432, the candidate determination function 433, and the value presentation function 434, which are components of the processing circuitry 43 illustrated in FIG. 2, are recorded in the memory 41 in a form of a program executable by a computer. The processing circuitry 43 is, for example, a processor. The processor constituting the processing circuitry 43 reads each program from the memory 41 and executes the program to implement a function corresponding to the read program. In other words, the processing circuitry 43 in a state of reading each program has each function illustrated in the processing circuitry 43 of FIG. 2.

Note that FIG. 2 illustrates a case where the processing functions of the acquisition function 431, the value calculation function 432, the candidate determination function 433, and the value presentation function 434 are implemented by the single processing circuitry 43, but the embodiment is not limited thereto. For example, the processing circuitry 43 may be constituted by combining a plurality of independent processors, and each of the processors may implement each processing function by executing each program. In addition, each processing function of the processing circuitry 43 may be implemented by being appropriately distributed or integrated into a single or a plurality of processing circuitries.

The acquisition function 431 acquires provision biological data held by a provider and necessary data indicating biological data required by a provision destination candidate of the provision biological data. Specifically, the acquisition function 431 receives and acquires provision biological data held by the information processing apparatus 2 of a provider from the information processing apparatus 2 via the communication interface 42. In addition, the acquisition function 431 receives and acquires necessary data held by the information processing apparatus 3 of a provision destination candidate from the information processing apparatus 3 via the communication interface 42.

The value calculation function 432 acquires (calculates) a value of the provision biological data on the basis of the provision biological data and the necessary data acquired by the acquisition function 431. The value of the provision biological data is, for example, a value corresponding to a medical cost deduction amount that can be applied to a tax office when the provision biological data is provided to a provision destination candidate.

The value calculation function 432 calculates the value of the provision biological data on the basis of a coincidence ratio between the provision biological data and the necessary data. The coincidence ratio between the provision biological data and the necessary data is a value obtained by dividing the coincidence number of items or combinations of an item and a value between the provision biological data and the necessary data by the number of items in the necessary data. The coincidence ratio may be a percentage.

For example, it is assumed that the items included in the provision biological data are “age”, “sex”, “total protein”, “albumin (ALB)”, “AST (GOT)”, “ALT (GPT)”, “y-GTP”, and “amylase”. In addition, it is assumed that the necessary data includes three items of “age”, “sex”, and “total protein”. In this case, since “age”, “sex”, and “total protein” coincide between the provision biological data and the necessary data, the coincidence number of items is three. In addition, the number of items in the necessary data is three. Therefore, the coincidence ratio is 3/3, that is, 100%. In addition, as another example of the necessary data, it is assumed that the necessary data includes “medical history: five years after remission of pancreatic cancer” which is a combination of an item and a value and two items of “amylase” and “CA19-9”. In this case, since “amylase” coincides between the above-described provision biological data and the necessary data, the coincidence number of items is one. In addition, the total number of items or combinations of an item and a value in the necessary data is 3. Therefore, the coincidence ratio is 1/3, that is, 33%.

For example, the value calculation function 432 calculates a higher value as a coincidence ratio between the provision biological data and the necessary data is higher.

The acquisition function 431 may further acquire a satisfaction level of the necessary data in the provision destination candidate. Specifically, the acquisition function 431 may receive and acquire a satisfaction level of necessary data held by the information processing apparatus 2 of a provider from the information processing apparatus 2 via the communication interface 42. The satisfaction level of the necessary data is an index indicating how much the biological data required by the provision destination candidate indicated in the necessary data is satisfied in the provision destination candidate. The satisfaction level may be a percentage. When the acquisition function 431 further acquires the satisfaction level of the necessary data, the value calculation function 432 may calculate a value of the provision biological data further on the basis of the satisfaction level acquired by the acquisition function 431. For example, the value calculation function 432 may calculate a lower value as the satisfaction level is higher.

The candidate determination function 433 determines a provision destination candidate. The acquisition function 431 acquires necessary data from the provision destination candidate determined by the candidate determination function 433. Specifically, the acquisition function 431 receives and acquires necessary data held by the information processing apparatus 3 of the provision destination candidate determined by the candidate determination function 433 from the information processing apparatus 3 via the communication interface 42.

The candidate determination function 433 determines a provision destination candidate on the basis of, for example, an input operation by a provider. Specifically, the candidate determination function 433 displays a selection screen for selecting a provision destination candidate on a display of the information processing apparatus 2 of a provider via the communication interface 42. In addition, the candidate determination function 433 receives an electrical signal of an input operation on the selection screen from the information processing apparatus 2 of the provider via the communication interface 42, and determines a provision destination candidate corresponding to the received electrical signal.

The value presentation function 434 presents the value of the provision biological data acquired (calculated) by the value calculation function 432 to the provider. For example, the value presentation function 434 presents the value of the provision biological data calculated by the value presentation function 434 to the provider by displaying an image indicating the value of the provision biological data on a display of the information processing apparatus 2 of the provider. In this case, the value presentation function 434 generates display data of the value of the provision biological data calculated by the value calculation function 432, that is, image data. Then, the value presentation function 434 transmits the generated display data to the information processing apparatus 2 of the provider via the communication interface 42 and displays the transmitted display data on a display of the information processing apparatus 2.

The value presentation function 434 may convert the value of the provision biological data calculated by the value calculation function 432 into an amount of money and present the amount of money. For example, the value presentation function 434 may convert the value of the provision biological data calculated by the value calculation function 432 into a medical cost deduction amount and present the medical cost deduction amount.

The processing circuitry 43 may further include a provision function of providing the provision biological data to a provision destination candidate according to an instruction from the provider to whom the value of the provision biological data has been presented. The provision function may receive an instruction to provide the provision biological data whose value has been presented to the provision destination candidate from the information processing apparatus 2 of the provider via the communication interface 42. The provision function may transmit and provide the provision biological data to the information processing apparatus 3 of the provision destination candidate via the communication interface 42 according to the reception of the instruction of the provision. Note that the provision biological data may be directly transmitted from the information processing apparatus 2 of the provider to the information processing apparatus 3 of the provision destination candidate.

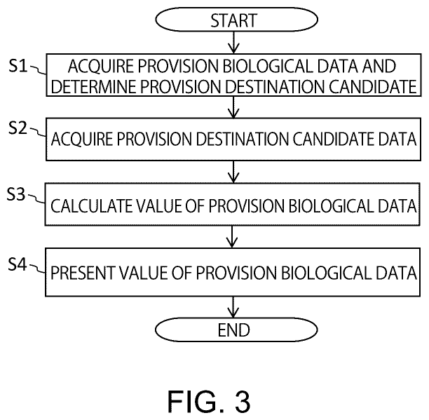

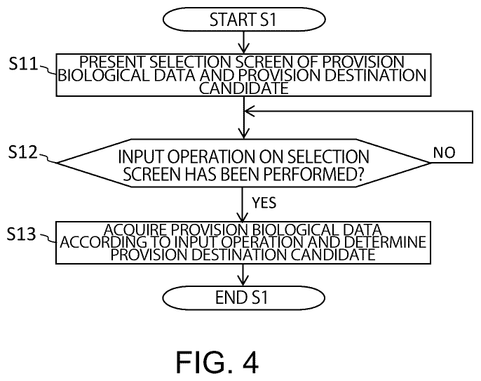

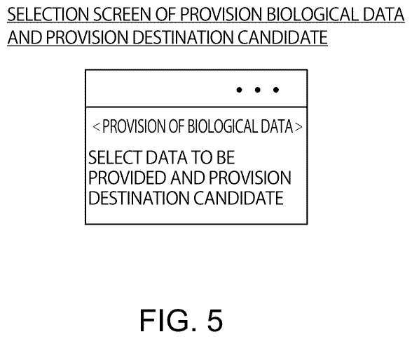

Next, an operation example of the biological information processing apparatus 4 according to the first embodiment configured as described above will be described. FIG. 3 is a flowchart illustrating an operation example of the biological information processing apparatus 4 according to the first embodiment. FIG. 4 is a flowchart illustrating a step of determining a provision destination candidate in the operation example of the biological information processing apparatus 4 according to the first embodiment. FIG. 5 is a diagram illustrating a selection screen used in the step of determining a provision destination candidate in the operation example of the biological information processing apparatus 4 according to the first embodiment.

As illustrated in FIG. 3, first, the acquisition function 431 acquires provision biological data, and the candidate determination function 433 determines a provision destination candidate (step S1). Specifically, as illustrated in FIG. 4, the acquisition function 431 and the candidate determination function 433 present a selection screen of the provision biological data and the provision destination candidate to a provider (step S11). The selection screen of the provision biological data and the provision destination candidate is a screen that receives an input operation of selecting provision biological data and an input operation of selecting a provision destination candidate of the provision biological data. The input operation of selecting provision biological data may be, for example, an operation of uploading provision biological data held by the information processing apparatus 2 of the provider to the selection screen. The input operation of selecting a provision destination candidate may be, for example, an input operation in which the provider selects a desired provision destination candidate from among options of the provision destination candidates provided by the candidate determination function 433 to the provider via the selection screen. The selection screen may be a screen on which a plurality of provision destination candidates can be selected. More specifically, when receiving an instruction to present the value of the biological data from the information processing apparatus 2 of the provider via the communication interface 42, the candidate determination function 433 generates display data of a selection screen of provision biological data and a provision destination candidate as illustrated in FIG. 5. After generating the display data of the selection screen, the candidate determination function 433 transmits the display data of the selection screen to the information processing apparatus 2 of the provider via the communication interface 42 to display the selection screen on a display of the information processing apparatus 2 of the provider.

After presenting the selection screen of the provision biological data and the provision destination candidate to the provider, the acquisition function 431 and the candidate determination function 433 determine whether or not an input operation of the provider on the selection screen has been performed (step S12). That is, the acquisition function 431 and the candidate determination function 433 determine whether or not an electrical signal of the input operation on the selection screen of the provision biological data and the provision destination candidate has been received via the communication interface 42.

If the input operation on the selection screen of the provision biological data and the provision destination candidate has been performed (step S12: YES), the acquisition function 431 acquires provision biological data held by the provider, selected according to the input operation (step S13). Specifically, the acquisition function 431 receives and acquires the provision biological data from the information processing apparatus 2 of the provider via the communication interface 42. In addition, the candidate determination function 433 determines a provision destination candidate selected according to the input operation (step S13). On the other hand, if the input operation on the selection screen of the provision biological data and the provision destination candidate has not been performed (step S12: NO), the acquisition function 431 and the candidate determination function 433 repeat determination as to whether or not the input operation by the provider on the selection screen has been performed (step S12).

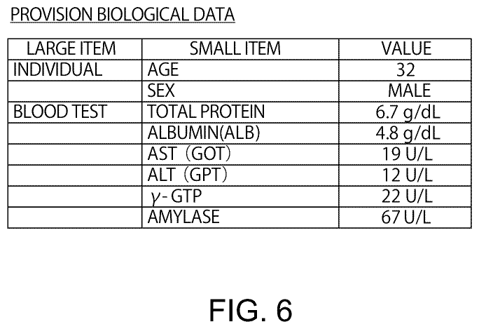

FIG. 6 is a diagram illustrating an example of provision biological data acquired in a step of acquiring provision biological data in the operation example of the biological information processing apparatus 4 according to the first embodiment. For example, the acquisition function 431 may acquire the provision biological data illustrated in FIG. 6. In the example illustrated in FIG. 6, the provision biological data is classified into two large items of a personal item “individual” and a test item “blood test”. The large item “individual” includes two small items of “age” and “sex”. The large item “blood test” includes six small items of “total protein”, “albumin (ALB)”, “AST (GOT)”, “ALT (GPT)”, “Y-GTP”, and “amylase”. Therefore, the provision biological data illustrated in FIG. 6 is classified into eight small items, and has a value (that is, a main body of data) for each small item.

After the acquisition of the provision biological data and the determination of the provision destination candidate, as illustrated in FIG. 3, the acquisition function 431 acquires provision destination candidate data from the determined provision destination candidate (step S2). The provision destination candidate data is data held by the information processing apparatus 3 of the provision destination candidate determined by the candidate determination function 433 and includes at least necessary data. Specifically, the acquisition function 431 receives and acquires the provision destination candidate data from the information processing apparatus 3 of the provision destination candidate determined by the candidate determination function 433 via the communication interface 42.

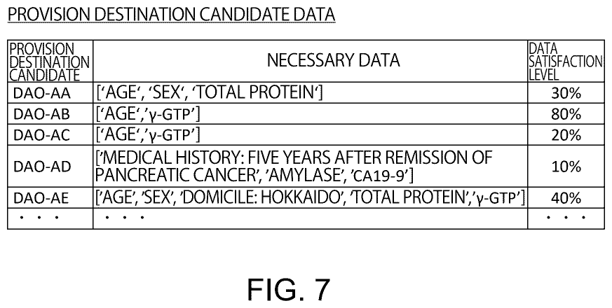

FIG. 7 is a diagram illustrating an example of provision destination candidate data acquired in a step of acquiring provision destination candidate data in the operation example of the biological information processing apparatus 4 according to the first embodiment. For example, the acquisition function 431 may acquire the provision destination candidate data illustrated in FIG. 7. Note that FIG. 7 illustrates an example in which a plurality of provision destination candidates has been determined by the candidate determination function 433, but the number of provision destination candidates may be one. In addition, FIG. 7 collectively illustrates provision destination candidate data individually acquired from each of the plurality of provision destination candidates. In the example illustrated in FIG. 7, the provision destination candidate data includes the name of a provision destination candidate, necessary data, and a satisfaction level of the necessary data.

As illustrated in provision destination candidate data of “DAO-AA” in FIG. 7, the necessary data includes items indicating biological data required by the provision destination candidate, such as, “age”, “sex”, and “total protein”. In addition, as illustrated in provision destination candidate data of “DAO-AD” and “DAO-AE” in FIG. 7, the necessary data may include a value of biological data required by the provision destination candidate, such as a value belonging to an item “medical history, “five years after remission of pancreatic cancer” or a value belonging to an item “domicile”, “Hokkaido”.

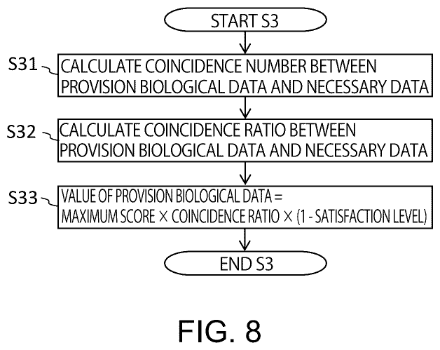

After the provision destination candidate data is acquired, the value calculation function 432 calculates a value of the provision biological data on the basis of the provision biological data and the provision destination candidate data acquired by the acquisition function 431 (step S3). FIG. 8 is a flowchart illustrating a step of calculating a value of provision biological data in the operation example of the biological information processing apparatus 4 according to the first embodiment.

Specifically, as illustrated in FIG. 8, first, the value calculation function 432 calculates the coincidence number between the provision biological data and the necessary data in the provision destination candidate data (step S31). In the example illustrated in FIGS. 6 and 7, all of the three items “age”, “sex”, and “total protein” constituting the necessary data of the provision destination candidate “DAO-AA” are included in the small items of the provision biological data. Therefore, the coincidence number between the necessary data of “DAO-AA” and the provision biological data is three. In addition, in the example illustrated in FIGS. 6 and 7, only one item “amylase” among one combination of an item and a value, “medical history: five years after remission of pancreatic cancer” and two items “amylase” and “CA19-9” constituting the necessary data of the provision destination candidate “DAO-AD” is included in the small items of the provision biological data. Therefore, the coincidence number between the necessary data of “DAO-AD” and the provision biological data is one.

After calculating the coincidence number, as illustrated in FIG. 8, the value calculation function 432 calculates a coincidence ratio between the provision biological data and the necessary data (step S32). In the example illustrated in FIG. 7, in “DAO-AA”, the number of items included in the necessary data is three (“age”, “sex”, and “total protein”), whereas the coincidence number is three. Therefore, a data coincidence ratio of “DAO-AA” is 3/3×100=100%. In addition, in the example illustrated in FIG. 7, in “DAO-AD”, the total number of items or combinations of an item and a value included in the necessary data is three (“medical history: five years after remission of pancreatic cancer”, “amylase”, and “CA19-9”), whereas the coincidence number is one. Therefore, a data coincidence ratio of “DAO-AD” is 1/3×100=33%.

After calculating the coincidence ratio, as illustrated in FIG. 8, the value calculation function 432 calculates a value of the provision biological data on the basis of the calculated coincidence ratio and the satisfaction level in the provision destination candidate data. Specifically, the value calculation function 432 calculates the value of the provision biological data according to the following formula (step S33).

$$Value of provision biological data = maximum score \times coincidence ratio \times ( 1 - satisfaction level ) \qquad ( 1 )$$

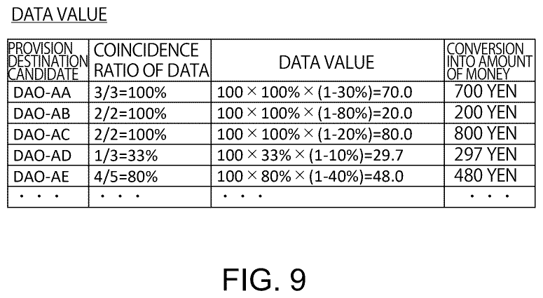

Note that, in mathematical formula (1), the maximum score is, for example, a constant determined from a relationship with an upper limit of a medical cost deduction amount. In the example illustrated in FIG. 9, the maximum score is 100. In addition, in mathematical formula (1), the coincidence ratio and the satisfaction level are not percentages (%) but ratios with 1 as a maximum value.

FIG. 9 is a diagram illustrating an example of a value calculated in the step of calculating a value of provision biological data in the operation example of the biological information processing apparatus 4 according to the first embodiment. As illustrated in FIG. 9, in “DAO-AA”, a coincidence ratio is 100%, a satisfaction level is 30%, that is, 0.3, and a maximum score is 100. Therefore, 70 points are calculated as a value of the provision biological data for “DAO-AA” by mathematical formula (1). In addition, as illustrated in FIG. 9, in “DAO-AD”, a coincidence ratio is 33%, a satisfaction level is 10%, that is, 0.1, and a maximum score is 100. Therefore, 29.7 points are calculated as a value of the provision biological data for “DAO-AD” by mathematical formula (1).

In the example illustrated in FIG. 9, the value calculation function 432 further calculates a value of the provision biological data converted into an amount of money. In the example illustrated in FIG. 9, the conversion into an amount of money is calculated by multiplying 1 point of value by 10 yen. Therefore, a converted amount of the value (70 points) of the provision biological data for “DAO-AA” is 700 yen. A converted amount of the value (29.7 points) of the provision biological data for “DAO-AD” is 297 yen.

After calculating the value of the provision biological data, as illustrated in FIG. 3, the value presentation function 434 presents the value of the provision biological data calculated by the value calculation function 432 to the provider (step S4). Specifically, the value presentation function 434 presents the value of the provision biological data to the provider by transmitting the value of the provision biological data calculated by the value calculation function 432 to the information processing apparatus 2 of the provider via the communication interface 42.

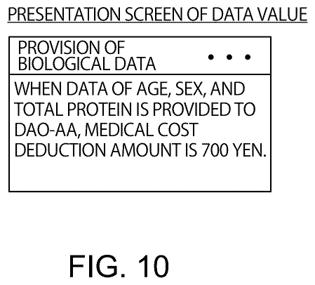

More specifically, the value presentation function 434 generates display data of a presentation screen for presenting the value of the provision biological data calculated by the value calculation function 432. After generating the display data of the presentation screen, the value presentation function 434 transmits the display data of the presentation screen to the information processing apparatus 2 of the provider via the communication interface 42 to display the presentation screen on a display of the information processing apparatus 2 of the provider. FIG. 10 is a diagram illustrating an example of a presentation screen displayed in a step of presenting a value of provision biological data in the operation example of the biological information processing apparatus 4 according to the first embodiment. For example, as illustrated in FIG. 10, the value presentation function 434 may display a presentation screen for converting the value of the provision biological data for the provision destination candidate into a medical cost deduction amount and presenting the medical cost deduction amount on a display of the information processing apparatus 2 of the provider.

Note that the presentation screen of the value of the provision biological data may receive an input operation of instructing provision of the provision biological data to the provision destination candidate displayed on the presentation screen. When the provision of the provision biological data is instructed, a provision function (not illustrated) of the processing circuitry 43 may transmit the provision biological data to the information processing apparatus 3 of the provision destination candidate via the communication interface 42.

As described above, in the first embodiment, the acquisition function 431 acquires provision biological data held by the provider and necessary data indicating biological data required by the provision destination candidate of the provision biological data. In addition, the value calculation function 432 calculates a value of the provision biological data on the basis of the provision biological data and the necessary data acquired by the acquisition function 431.

As a result, since the value of the provision biological data in consideration of necessity of the provision destination candidate can be calculated, the value of the provision biological data can be appropriately calculated. As a result, since it is possible to encourage the provider to provide necessary biological data to a necessary provision destination, it is possible to promote utilization of the biological data. Promoting utilization of the biological data can contribute to development of a related technical field.

In addition, in the first embodiment, the candidate determination function 433 determines a provision destination candidate. In addition, the acquisition function 431 acquires necessary data from the provision destination candidate determined by the candidate determination function 433.

As a result, since provision destination candidates can be narrowed down in advance from among a large number of organizations existing on the network 5, processing efficiency of the processing circuitry 43 (processor) when necessary data is acquired from the provision destination candidates can be improved.

In addition, in the first embodiment, the candidate determination function 433 determines a provision destination candidate on the basis of an input operation by a provider.

As a result, it is possible to determine a provision destination candidate faithfully reflecting an intention of the provider. Therefore, it is possible to avoid use of a work area of the processing circuitry 43 for calculating a value of provision biological data for an unnecessary provision destination candidate. As a result, it is possible to improve processing efficiency of the processing circuitry 43 when the value of the provision biological data is calculated.

In addition, in the first embodiment, the value calculation function 432 calculates the value of the provision biological data on the basis of a coincidence ratio between the provision biological data and the necessary data.

As a result, since the value of the provision biological data can be calculated by a simple method, the processing efficiency of the processing circuitry 43 when the value of the provision biological data is calculated can be improved.

In addition, in the first embodiment, the acquisition function 431 further acquires a satisfaction level of the necessary data in the provision destination candidate. In addition, the value calculation function 432 calculates the value of the provision biological data further on the basis of the satisfaction level acquired by the acquisition function 431.

As a result, since the value of the provision biological data can be more appropriately calculated on the basis of the satisfaction level, reliability with respect to the value of the provision biological data can be improved.

In addition, in the first embodiment, the value presentation function 434 presents the value of the provision biological data calculated by the value calculation function 432 to the provider.

As a result, since the provider can determine whether or not to present the provision biological data to the provision destination candidate on the basis of the presented value, the provision destinations of the provision biological data can be narrowed down from among the provision destination candidates. As a result, when the provision biological data is provided from the information processing apparatus 2 of the provider to the information processing apparatus 3 of the provision destination candidate, processing efficiency of a processor of the information processing apparatus 2 when the provision biological data is provided can be improved. In addition, when the provision biological data is provided from the biological information processing apparatus 4 to the information processing apparatus 3 of the provision destination candidate, processing efficiency of the processing circuitry 43 of the biological information processing apparatus 4 when the provision biological data is provided can be improved.

In addition, in the first embodiment, the value presentation function 434 converts the value of the provision biological data calculated by the value calculation function 432 into an amount of money and presents the amount of money.

As a result, since it is possible to more effectively encourage the provider to provide the biological data by presenting the monetary value of the provision biological data, it is possible to further promote the utilization of the biological data.

In addition, in the first embodiment, the provision biological data includes an item for classifying biological data and a value of the biological data belonging to the item. In addition, the necessary data includes items for classifying the biological data.

As a result, the value of the provision biological data can be efficiently calculated by comparing items between the provision biological data and the necessary data. Therefore, processing efficiency of the processing circuitry 43 when the value of the provision biological data is calculated can be improved. In addition, it is possible to flexibly cope with a case where the provision destination candidate requires biological data of a specific item.

### First Modification of First Embodiment

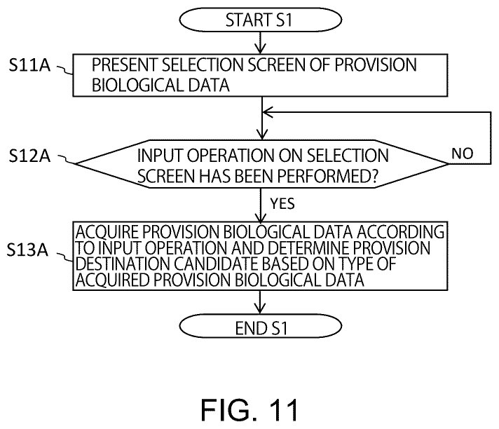

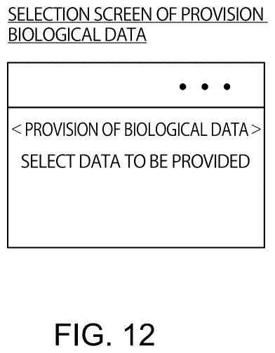

Next, a first modification of the first embodiment for determining a provision destination candidate on the basis of the type of provision biological data will be described focusing on a difference from the above-described embodiment. FIG. 11 is a flowchart illustrating a step of determining a provision destination candidate in an operation example of a biological information processing apparatus 4 according to a first modification of the first embodiment. FIG. 12 is a diagram illustrating a selection screen used in the step of determining a provision destination candidate in the operation example of the biological information processing apparatus 4 according to the first modification of the first embodiment.

As illustrated in FIG. 11, in the first modification of the first embodiment, in acquisition of provision biological data and determination of a provision destination candidate (step S1), the acquisition function 431 first presents a selection screen of the provision biological data to a provider (step S11A). The selection screen of the provision biological data is a screen that receives an input operation of selecting the provision biological data. The selection screen may be a screen on which a plurality of pieces of provision biological data can be selected. More specifically, when receiving an instruction to present the value of the biological data from the information processing apparatus 2 of the provider via the communication interface 42, the candidate determination function 433 generates display data of the selection screen of the provision biological data as illustrated in FIG. 12. After generating the display data of the selection screen, the candidate determination function 433 transmits the display data of the selection screen to the information processing apparatus 2 of the provider via the communication interface 42 to display the selection screen on a display of the information processing apparatus 2 of the provider.

After presenting the selection screen of the provision biological data to the provider, the acquisition function 431 determines whether or not the input operation of the provider on the selection screen has been performed (step S12A). That is, the candidate determination function 433 determines whether or not an electrical signal of the input operation on the selection screen of the provision biological data has been received via the communication interface 42.

If the input operation on the selection screen of the provision biological data has been performed (step S12A: YES), the acquisition function 431 acquires provision biological data according to the input operation, and the candidate determination function 433 determines a provision destination candidate on the basis of the type of the acquired provision biological data (step S13A). For example, when the type of the provision biological data is electrocardiogram data, the candidate determination function 433 determines a heart disease DAO as the provision destination candidate. In addition, for example, when the type of the provision biological data is COVID-19 sequelae data, the candidate determination function 433 determines a sequelae analysis DAO as the provision destination candidate. The candidate determination function 433 may determine the type of the provision destination candidate data on the basis of additional information indicating the type of the provision destination candidate data added to the provision destination candidate data. Alternatively, the candidate determination function 433 may determine the type of the provision destination candidate data on the basis of an item included in the provision destination candidate data.

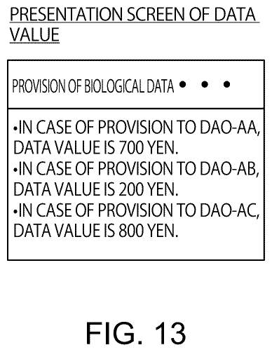

FIG. 13 is a diagram illustrating a presentation screen presented in a step of presenting a value of provision biological data in the operation example of the biological information processing apparatus 4 according to the first modification of the first embodiment. In the first modification of the first embodiment, since the provision destination candidate is determined on the basis of the type of the provision destination candidate data, a plurality of provision destination candidates may be determined. When a plurality of provision destination candidates is determined, the value calculation function 432 calculates a value of the provision destination candidate data for each of the provision destination candidates. Then, as illustrated in FIG. 13, the value presentation function 434 simultaneously presents the value for each of the provision destination candidates.

As described above, in the first modification of the first embodiment, the candidate determination function 433 determines the provision destination candidate on the basis of the type of the provision biological data.

As a result, it is possible to reduce an operational burden on the provider when the provision destination candidate is determined. In addition, since the provision destination can be determined on the basis of the presented value for each of the provision destination candidates, convenience can be improved.

### Second Modification of First Embodiment

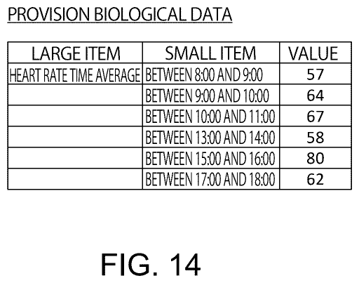

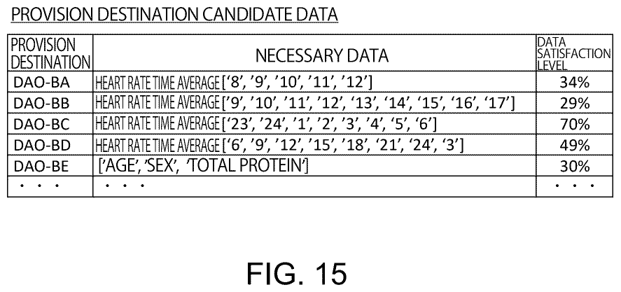

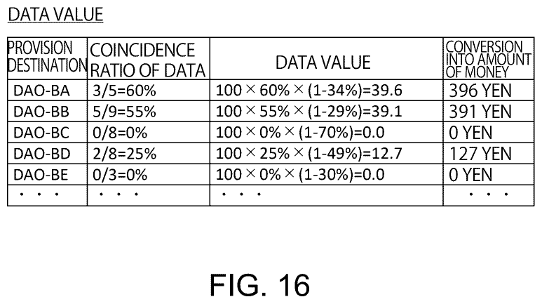

Next, a second modification of the first embodiment in which an item of the provision biological data and an item of the necessary data each include a detection time period of biological data will be described focusing on a difference from the above-described embodiment. FIG. 14 is a diagram illustrating provision biological data acquired in a step of acquiring provision biological data in an operation example of a biological information processing apparatus 4 according to the second modification of the first embodiment. FIG. 15 is a diagram illustrating provision destination candidate data acquired in a step of acquiring provision destination candidate data in the operation example of the biological information processing apparatus 4 according to the second modification of the first embodiment. FIG. 16 is a diagram illustrating a value calculated in a step of calculating a value of provision biological data in the operation example of the biological information processing apparatus 4 according to the second modification of the first embodiment.

As illustrated in FIG. 14, in the second modification of the first embodiment, the provision biological data includes, as a small item belonging to a large item “heart rate time average”, a small item indicating a detection time period of a heart rate time average such as “between 8:00 and 9:00”, “between 9:00 and 10:00”, or “between 10:00 and 11:00”. In addition, the provision biological data includes, as a value belonging to the small item, a value of heart rate time average detected in the detection time period. In addition, as illustrated in FIG. 15, in the second modification of the first embodiment, the necessary data includes an item indicating a detection time period of heart rate time average such as “8”, “9”, or “10”. According to the second modification of the first embodiment, a value can be calculated and presented as illustrated in FIG. 16 even for a time-series change of the same type of biological data such as heart rate time average. Note that weighting may be performed on the necessary data such that a value of provision biological data is higher in a case where a provider provides provision biological data in a continuous time period (for example, between 8:00 and 9:00 and between 9:00 and 10:00) than in a case where the provider provides provision biological data in an intermittent time period (for example, between 8:00 and 9:00 and between 10:00 and 11:00).

As described above, in the second modification of the first embodiment, the item of the provision biological data and the item of the necessary data each include the detection time period of the biological data.

As a result, versatility and the degree of freedom for calculation of the value of the provision biological data can be improved.

### Third Modification of First Embodiment

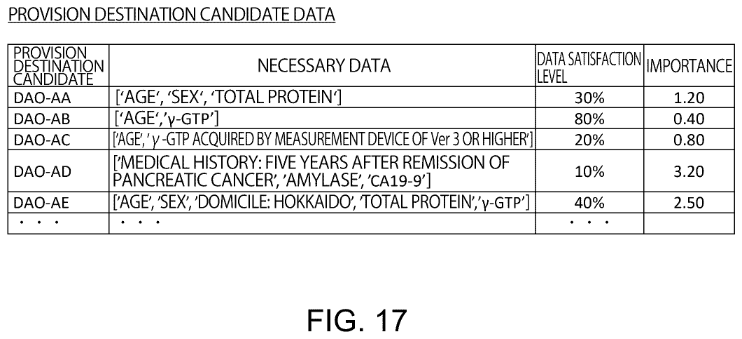

Next, a third modification of the first embodiment for calculating a value of provision biological data further on the basis of importance will be described focusing on a difference from the above-described embodiment. FIG. 17 is a diagram illustrating provision destination candidate data acquired in a step of acquiring provision destination candidate data in an operation example of a biological information processing apparatus 4 according to the third modification of the first embodiment;

As illustrated in FIG. 17, in the third modification of the first embodiment, the provision destination candidate data further includes importance of biological data. The importance is an example of information regarding importance of necessary information. The importance may be, for example, a value set on the basis of an index obtained by a third party evaluating a provision destination candidate (DAO). The index for evaluating the provision destination candidate may be, for example, an economic effect when a study using biological data indicated in the necessary data is established or an economic effect obtained when a hospital utilizes the biological data indicated in the necessary data.

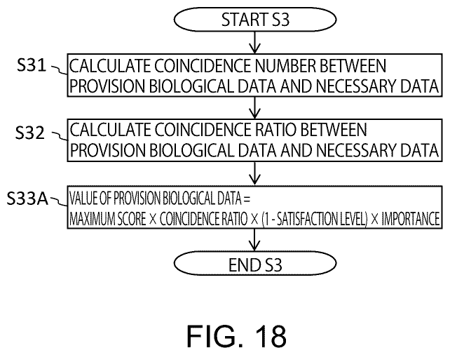

FIG. 18 is a flowchart illustrating a step of calculating a value of provision biological data in the operation example of the biological information processing apparatus 4 according to the third modification of the first embodiment. As illustrated in FIG. 18, in the third modification of the first embodiment, the value calculation function 432 calculates a value of the provision biological data according to the following formula after a coincidence ratio is calculated (step S33A).

$$Value of provision biological data = maximum score \times coincidence ratio \times ( 1 - satisfaction level ) \times importance \qquad ( 2 )$$

As described above, in the third modification of the first embodiment, the value calculation function 432 calculates a value of the provision biological data further on the basis of the importance.

As a result, since the value of the provision biological data can be more appropriately calculated on the basis of the importance, reliability with respect to the value of the provision biological data can be further improved.

### Fourth Modification of First Embodiment

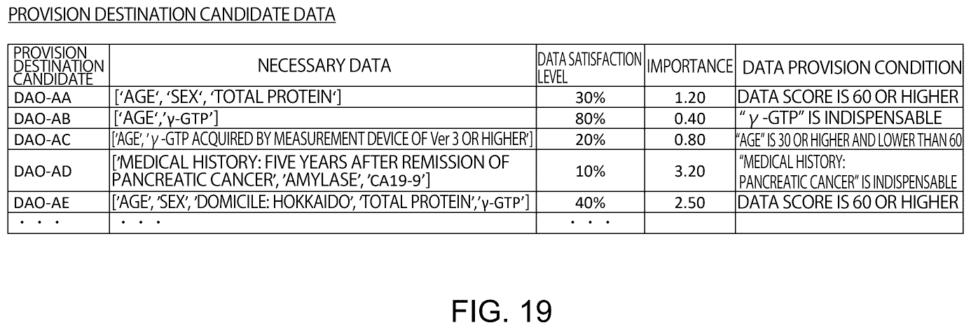

Next, a fourth modification of the first embodiment for calculating a value of provision biological data further on the basis of a provision condition of the provision biological data to a provision destination candidate will be described focusing on a difference from the above-described embodiment. FIG. 19 is a diagram illustrating provision destination candidate data acquired in a step of acquiring provision destination candidate data in an operation example of a biological information processing apparatus 4 according to the fourth modification of the first embodiment.

As illustrated in FIG. 19, in the fourth modification of the first embodiment, the provision destination candidate data further includes a provision condition of provision biological data to a provision destination candidate, that is, a data provision condition, in addition to the data structure of the third modification of the first embodiment. For example, the data provision condition for “DAO-AA” is that a score of biological data is 60 or higher. The data provision condition for “DAO-AB” is that y-GTP is necessarily included in biological data.

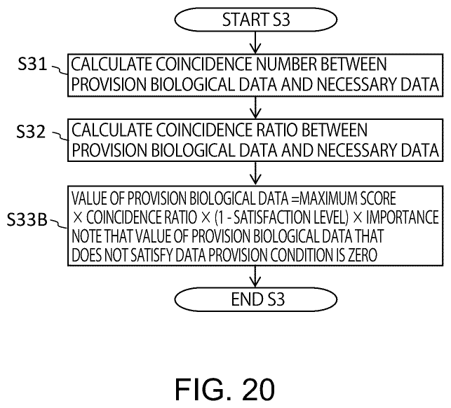

FIG. 20 is a flowchart illustrating a step of calculating a value of provision biological data in the operation example of the biological information processing apparatus 4 according to the fourth modification of the first embodiment. As illustrated in FIG. 20, in the fourth modification of the first embodiment, the value calculation function 432 calculates a value of provision biological data according to mathematical formula (2) described in the third modification of the first embodiment. Note that a value of the provision biological data that does not satisfy the data provision condition is set to zero (step S33B).

As described above, in the fourth modification of the first embodiment, the value calculation function 432 calculates a value of the provision biological data further on the basis of the data provision condition.

As a result, since the value of the provision biological data can be more appropriately calculated on the basis of the data provision condition, reliability with respect to the value of the provision biological data can be further improved.

### Fifth Modification of First Embodiment

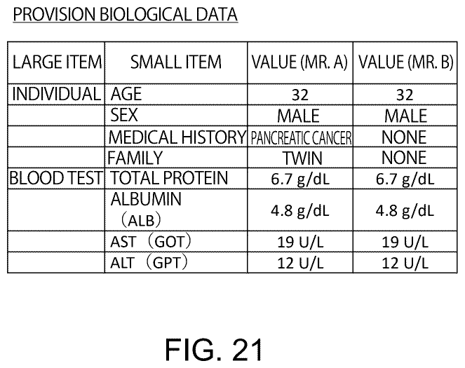

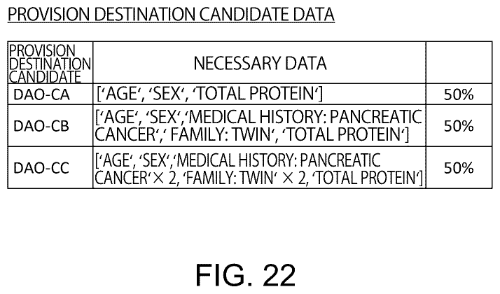

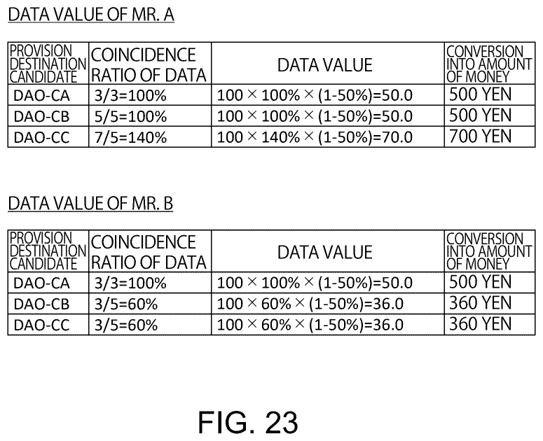

Next, a fifth modification of the first embodiment for calculating a value of provision biological data further on the basis of weighting of necessary data will be described focusing on a difference from the above-described embodiment. FIG. 21 is a diagram illustrating provision biological data acquired in a step of acquiring provision biological data in an operation example of a biological information processing apparatus 4 according to the fifth modification of the first embodiment. FIG. 22 is a diagram illustrating provision destination candidate data acquired in a step of acquiring provision destination candidate data in the operation example of the biological information processing apparatus 4 according to the fifth modification of the first embodiment. FIG. 23 is a diagram illustrating a value calculated in a step of calculating a value of provision biological data in the operation example of the biological information processing apparatus 4 according to the fifth modification of the first embodiment.

As illustrated in FIG. 21, in the fifth modification of the first embodiment, when provision biological data of two subjects, Mr. A and Mr. B is provided, values of the provision biological data of the two subjects are described while being compared. As illustrated in FIG. 21, the provision biological data of Mr. A and the provision biological data of Mr. B are different in medical history (presence or absence of pancreatic cancer) and family structure (presence or absence of twin), and are the same in the other items.

As illustrated in the provision destination candidate data of “DAO-CC” in FIG. 22, among the plurality of provision destination candidates, there is a provision destination candidate in which weighting is performed on an item of necessary data. In the necessary data of “DAO-CC”, weighting is performed on an item of “pancreatic cancer” so as to double the coincidence number of data, and weighting is performed on an item of an item of “twin” so as to double the coincidence number of data. The weighting is an example of information regarding importance of the necessary information.

As illustrated in FIG. 23, for “DAO-CC”, a data coincidence ratio of the provision biological data of Mr. A including the item of “pancreatic cancer” and the item of “twin” exceeds 100% and is 140% by weighting. Therefore, the value of the provision biological data of Mr. A on which weighting is performed is calculated to be a higher value than that in a case where no weighting is performed. On the other hand, a coincidence ratio of the provision biological data of Mr. B not including the item of “pancreatic cancer” and the item of “twin” is 60% by the same method as that of the above-described embodiment.

As described above, in the fifth modification of the first embodiment, the value calculation function 432 calculates a value of the provision biological data further on the basis of weighting of the necessary data.

As a result, since the value of the provision biological data can be more appropriately calculated on the basis of the weighting, reliability with respect to the value of the provision biological data can be further improved.

### Sixth Modification of First Embodiment

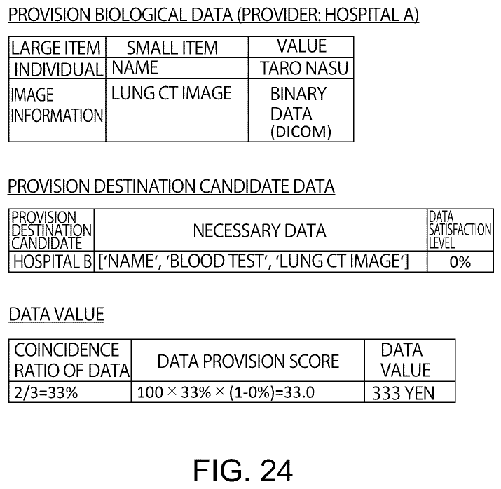

FIG. 24 is a diagram illustrating provision biological data, provision destination candidate data, and a value of the provision biological data in an operation example of a biological information processing apparatus 4 according to a sixth modification of the first embodiment. The example in which the provider of the provision biological data is an individual has been described above. On the other hand, as illustrated in FIG. 24, the provider of the provision biological data may be a hospital (hospital A in FIG. 24) holding provision biological data of a patient (that is, an individual) acquired by performing a test on the patient. In addition, as illustrated in FIG. 24, the provision destination candidate may be a hospital (hospital B in FIG. 24) other than the provider at which the patient whose provision biological data has been detected has got a check-up. For example, there is a case where a patient gets a check-up at a hospital on a provision destination candidate side with an introduction letter from a hospital on a provider side. In this case, the hospital on the provision destination candidate side does not need to perform a new test if the hospital on the provision destination candidate side receives provision of the provision biological data from the hospital on the provider side. As a result, the hospital on the provision destination candidate side can reduce resources such as labor cost and electricity cost required for a new test, and can implement efficient medical care. In addition, the provider may obtain a medical care fee for providing the provision biological data. In addition, even when the provision destination candidate is a rare disease case database and the provider provides case data of a patient with a rare disease to the case database, a medical care fee may be obtained according to a value of the case data.

### Seventh Modification of First Embodiment

An example has been described above in which a provider can determine whether or not to provide provision biological data to a provision destination candidate by presenting a value of provision of the provision biological data for the provision destination candidate to the provider. On the other hand, the value presentation function 434 may present the value of the provision biological data also to the provision destination candidate. The value presented to the provision destination candidate may be limited to a value equal to or higher than a threshold. As a result, the provision destination candidate can grasp provision biological data having a high value for the provision destination candidate from among a plurality of pieces of provision biological data, and therefore can act on a provider holding provision biological data having a high value to provide the provision biological data. As a result, utilization of the provision biological data can be further promoted. For example, in a situation where there is a large amount of provision biological data and a DAO wants to collect, for example, 1000 examples of provision biological data for AI learning, it is also possible to preferentially take in provision biological data having a high value.

### Eighth Modification of First Embodiment

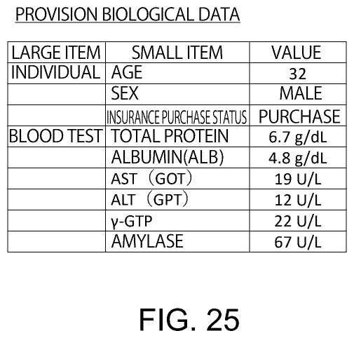

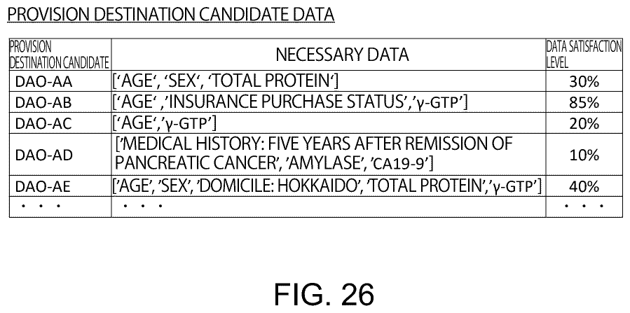

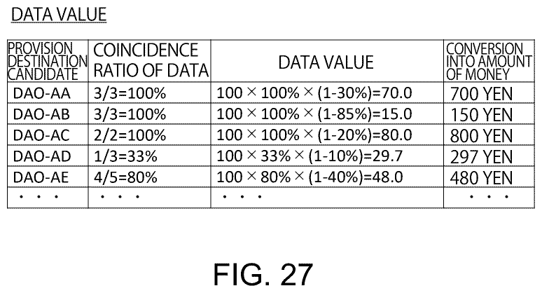

Next, an eighth modification of the first embodiment for calculating a value of provision biological data further in consideration of an insurance purchase status will be described focusing on a difference from the above-described embodiment. FIG. 25 is a diagram illustrating provision biological data acquired in a step of acquiring provision biological data in an operation example of a biological information processing apparatus 4 according to the eighth modification of the first embodiment. FIG. 26 is a diagram illustrating provision destination candidate data acquired in a step of acquiring provision destination candidate data in the operation example of the biological information processing apparatus 4 according to the eighth modification of the first embodiment. FIG. 27 is a diagram illustrating an example of a value calculated in a step of calculating a value of provision biological data in the operation example of the biological information processing apparatus 4 according to the eighth modification of the first embodiment.

In the example illustrated in FIG. 25, the acquisition function 431 acquires provision biological data including an insurance purchase status (step S1 in FIG. 3). More specifically, in the example illustrated in FIG. 25, the provision biological data includes, as one of personal items, “insurance purchase status”, that is, a medical insurance purchase status of a provider. The medical insurance is, for example, public medical insurance. The medical insurance is not limited to the public medical insurance, and may be private medical insurance. In the example illustrated in FIG. 25, a value of biological data for the item of the insurance purchase status is “purchase”.

In the example illustrated in FIG. 26, the acquisition function 431 acquires provision destination candidate data including the insurance purchase status from the provision destination candidates determined on the basis of the input operation on the selection screen (FIG. 5) (step S2 in FIG. 3). More specifically, in the example illustrated in FIG. 26, the provision destination candidate data of “DAO-AB” includes” insurance purchase status” as necessary data.

In the example illustrated in FIG. 27, the value calculation function 432 calculates a value of provision biological data in consideration of an insurance purchase status on the basis of the provision biological data and the provision destination candidate data acquired by the acquisition function 431 (step S3 in FIG. 3). The value calculation function 432 calculates the value of the provision biological data according to mathematical formula (1). More specifically, in the example illustrated in FIG. 26, all of the three items “age”, “insurance purchase status”, and “y-GTP” constituting the necessary data of the provision destination candidate “DAO-AB” are included in the small items of the provision biological data. Therefore, the coincidence number between the necessary data of “DAO-AB” and the provision biological data is three. Therefore, a data coincidence ratio of “DAO-AB” is 3/3×100=100%. In addition, as illustrated in FIG. 27, in “DAO-AB”, a satisfaction level is 85%, that is, 0.85, and a maximum score is 100. Therefore, 15 points are calculated as a value of the provision biological data for “DAO-AB” by mathematical formula (1). The value calculation function 432 further calculates a value of the provision biological data converted into an amount of money. In the example illustrated in FIG. 27, the conversion into an amount of money is calculated by multiplying 1 point of value by 10 yen. Therefore, a converted amount of the value (15 points) of the provision biological data for “DAO-AB” is 150 yen. In this way, the value of the provision biological data in consideration of an insurance purchase status is calculated.

According to the examples illustrated in FIGS. 25 to 27, since it is possible to calculate a value of provision biological data in consideration of an insurance purchase status, it is possible to further improve versatility and the degree of freedom in calculating the value of the provision biological data.

### Second Embodiment

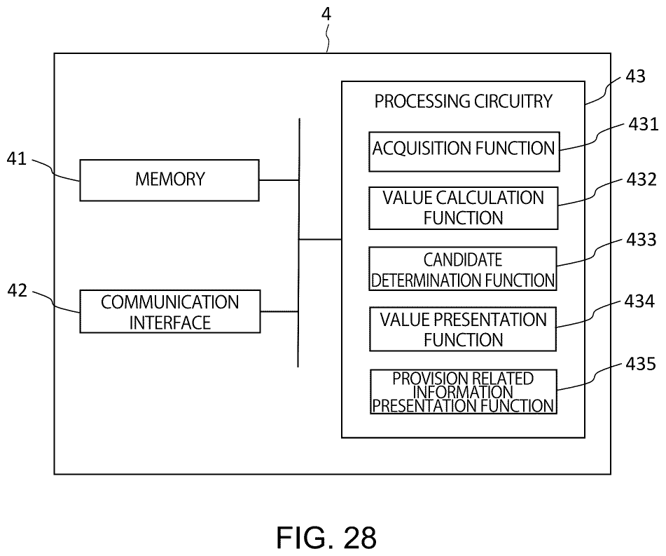

Next, a second embodiment for presenting possibility of provision of provision biological data on the basis of a value of the provision biological data will be described focusing on a difference from the above-described embodiment. FIG. 28 is a block diagram illustrating a configuration example of a biological information processing apparatus 4 according to the second embodiment. As illustrated in FIG. 28, a processing circuitry 43 of the biological information processing apparatus 4 according to the second embodiment further includes a provision related information presentation function 435 in addition to the configuration of the first embodiment. The provision related information presentation function 435 presents, to a provider, provision related information regarding provision of provision biological data to a provision destination candidate on the basis of a value of provision biological data calculated by a value calculation function 432. More specifically, in the second embodiment, the provision related information presentation function 435 presents possibility of provision of the provision biological data to the provision destination candidate as the provision related information.

For example, the provision related information presentation function 435 presents that it is possible to provide provision biological data having a value equal to or higher than a threshold and presents that it is impossible to provide provision biological data having a value less than the threshold. The threshold of the value may be, for example, a value that is one yen when converted into an amount of money. In addition, the provision related information presentation function 435 may present that it is impossible to provide provision biological data having a value equal to or higher than the threshold when a data provision condition of a provision destination candidate is not satisfied.

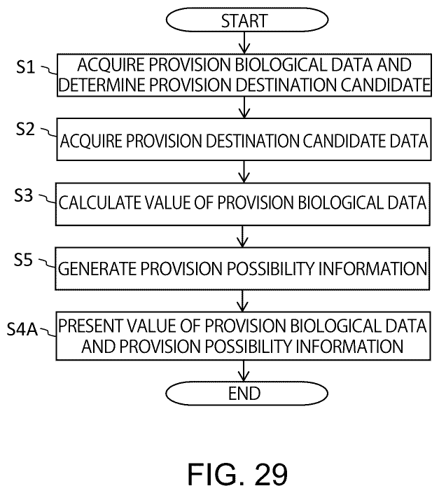

FIG. 29 is a flowchart illustrating an operation example of the biological information processing apparatus 4 according to the second embodiment. As illustrated in FIG. 29, in the second embodiment, after a value of provision biological data is calculated by the value calculation function 432, the provision related information presentation function 435 generates provision possibility information indicating possibility of provision of the provision biological data to a provision destination candidate on the basis of the calculated value (step S5).

After the provision possibility information is generated, a value presentation function 434 presents, to a provider, the provision possibility information generated by the provision related information presentation function 435 together with the value of the provision biological data (step S4A).

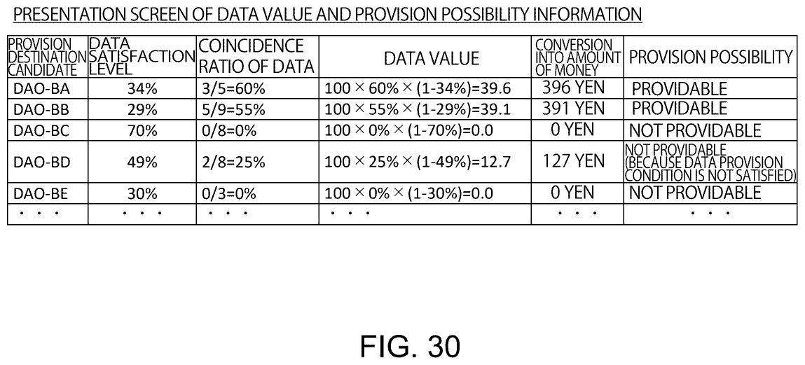

FIG. 30 is a diagram illustrating a value of provision biological data and provision possibility information presented in a step of presenting the value of the provision biological data and the provision possibility information in the operation example of the biological information processing apparatus 4 according to the second embodiment. For example, the value presentation function 434 may display a presentation screen of the provision biological data and the provision possibility information as illustrated in FIG. 30 on an information processing apparatus 2 of the provider. In the example illustrated in FIG. 30, it is presented that it is impossible to provide provision biological data to a provision destination candidate in which a value of the provision biological data converted into an amount of money is 0 yen. In addition, it is presented that it is impossible to provide provision biological data to a provision destination candidate not satisfying the data provision condition even when the value of the provision biological data converted into an amount of money is 1 yen or more. In addition, it is presented that it is possible to provide provision biological data to a provision destination candidate satisfying the data provision condition when the value of the provision biological data converted into an amount of money is 1 yen or more.

As described above, in the second embodiment, the provision related information presentation function 435 presents, to a provider, provision related information regarding provision of provision biological data to a provision destination candidate on the basis of a value of the provision biological data calculated by the value calculation function 432. The provision related information presentation function 435 presents possibility of provision of the provision biological data to a provision destination candidate as the provision related information.

As a result, it is possible for the provider to narrow down provision destination candidates to which the provision biological data is to be provided from among a large number of provision destination candidates on the basis of the possibility of provision. As a result, when the provision biological data is provided from the information processing apparatus 2 of the provider to the information processing apparatus 3 of the provision destination candidate, processing efficiency of a processor of the information processing apparatus 2 when the provision biological data is provided can be improved. In addition, when the provision biological data is provided from the biological information processing apparatus 4 to the information processing apparatus 3 of the provision destination candidate, processing efficiency of the processing circuitry 43 of the biological information processing apparatus 4 when the provision biological data is provided can be improved.

### First Modification of Second Embodiment

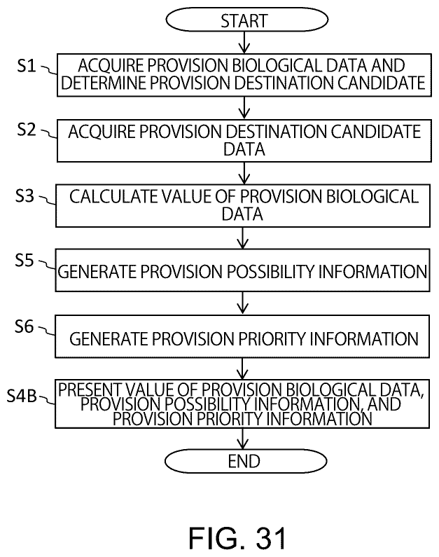

Next, a first modification of the second embodiment for presenting priority of provision of provision of biological data on the basis of a value of the provision biological data will be described focusing on a difference from the above-described embodiment. FIG. 31 is a flowchart illustrating an operation example of a biological information processing apparatus 4 according to the first modification of the second embodiment. As illustrated in FIG. 31, in the first modification of the second embodiment, after generating provision possibility information, the provision related information presentation function 435 generates provision priority information indicating priority of provision of provision biological data to a provision destination candidate on the basis of the calculated value (step S6). Note that the generation of the provision priority information may be performed before the generation of the provision possibility information or at the same time as the generation of the provision possibility information.

After the provision priority information is generated, the value presentation function 434 presents, to a provider, the provision priority information generated by the provision related information presentation function 435 together with the value of the provision biological data and the provision possibility information (step S4B).

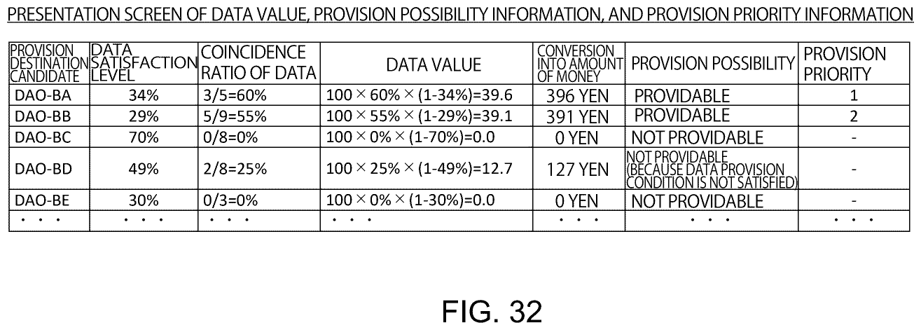

FIG. 32 is a diagram illustrating a value of provision biological data, provision possibility information, and provision priority information presented in a step of presenting the value of the provision biological data, the provision possibility information, and the provision priority information in the operation example of the biological information processing apparatus 4 according to the first modification of the second embodiment. For example, the value presentation function 434 may display a presentation screen of provision biological data, provision possibility information, and provision priority information as illustrated in FIG. 32 on the information processing apparatus 2 of the provider. In the example illustrated in FIG. 32, high (that is, small value) provision priority is presented in descending order of value of the provision biological data among provision destination candidates presented to be providable.

As described above, in the first modification of the second embodiment, the provision related information presentation function 435 presents priority of provision of the provision biological data to the provision destination candidate as the provision related information.

As a result, it is possible for the provider to further narrow down provision destination candidates to which the provision biological data is to be provided from among a large number of provision destination candidates on the basis of possibility of provision. As a result, when the provision biological data is provided from the information processing apparatus 2 of the provider to the information processing apparatus 3 of the provision destination candidate, processing efficiency of a processor of the information processing apparatus 2 when the provision biological data is provided can be further improved. In addition, when the provision biological data is provided from the biological information processing apparatus 4 to the information processing apparatus 3 of the provision destination candidate, processing efficiency of the processing circuitry 43 of the biological information processing apparatus 4 when the provision biological data is provided can be further improved.

Note that the provision possibility information and the provision priority information described in the second embodiment may also be presented to the provision destination candidate.

In addition, a specific aspect of the calculation of the value of the provision biological data by the value calculation function 432 is not limited to the above-described aspect. For example, when a DAO is constituted using a blockchain, the value calculation function 432 may calculate the value of the provision biological data on the basis of a reward obtained by blockchain mining. In addition, the value calculation function 432 may calculate the value of the provision biological data using AI or machine learning such as deep learning.

### Third Embodiment

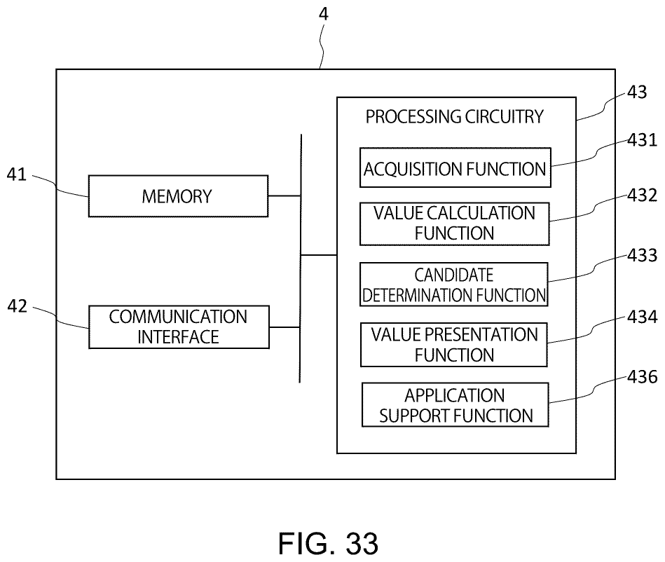

Next, a third embodiment for supporting an application for medical deduction will be described focusing on a difference from the above-described embodiment. FIG. 33 is a block diagram illustrating a configuration example of a biological information processing apparatus 4 according to the third embodiment. As illustrated in FIG. 33, a processing circuitry 43 of the biological information processing apparatus 4 according to the third embodiment further includes an application support function 436 in addition to the configuration of the first embodiment. The application support function 436 performs application support processing of supporting a procedure of applying for medical cost deduction by an individual provider on the basis of a value of provision biological data calculated by a value calculation function 432. A specific aspect of the application support processing is not particularly limited. For example, the application support processing may be processing of calculating a medical cost deduction amount in consideration of a converted amount of a value of provision biological data calculated by the value calculation function 432 and displaying the calculated medical cost deduction amount on an application screen displayed on the information processing apparatus 2 when a provider performs electronic application for medical cost deduction using the application screen. In this case, the application support function 436 may acquire information necessary for calculating the medical cost deduction amount such as an income amount of the provider from the provider via the information processing apparatus 2. Alternatively, the application support processing may be processing of notifying the provider of a converted amount of value of provision biological data calculated by the value calculation function 432 predetermined days before an application deadline of medical cost deduction.

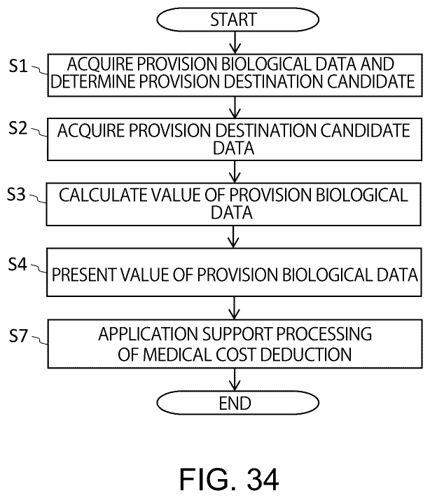

FIG. 34 is a flowchart illustrating an operation example of the biological information processing apparatus 4 according to the third embodiment. As illustrated in FIG. 34, in the third embodiment, after the value of the provision biological data is presented (step S4), the application support function 436 performs application support processing of medical cost deduction at a predetermined timing before the application deadline of the medical cost deduction (step S7).

According to the third embodiment, it is possible to support application of medical cost deduction by a provider, and thus, it is possible to improve convenience.

Note that the term “processor” used in the above description means, for example, a central processing unit (CPU), a graphics processing unit (GPU), or a circuit such as an application specific integrated circuit (ASIC), a programmable logic device (for example, a simple programmable logic device (SPLD)), a complex programmable logic device (CPLD), or a field programmable gate array (FPGA). The processor implements a function thereof by reading and executing a program stored in a memory. Note that, instead of storing the program in the memory, the program may be directly incorporated in a circuit of the processor. In this case, the processor implements a function thereof by reading and executing a program incorporated in the circuit. Note that the processor is not limited to a processor configured as a single processor circuit, and may implement a function thereof by combining a plurality of independent circuits to constitute one processor. Furthermore, the processor may implement a function thereof by integrating a plurality of components in FIG. 2 into one processor.

According to the at least one embodiment described above, a value of biological information to be provided can be appropriately calculated.

Although several embodiments have been described above, these embodiments have been presented only as examples, and are not intended to limit the scope of the invention. The novel apparatus and method described in the present specification can be implemented in a variety of other forms. In addition, various omissions, substitutions, and changes can be made to the forms of the apparatus and the method described in the present specification without departing from the gist of the invention. The appended claims and their equivalents are intended to include such forms and modifications included in the scope and gist of the invention.

What is claimed is:

1. A biological information processing apparatus comprising:
processing circuitry configured to acquire provision biological information held by a provider and necessary information indicating biological information required by a provision destination candidate of the provision biological information, and
to acquire a value of the provision biological information based on the acquired provision biological information and the necessary information.

2. The biological information processing apparatus according to claim 1, wherein
the processing circuitry is further configured to determine the provision destination candidate, and
to acquire the necessary information from the determined provision destination candidate.

3. The biological information processing apparatus according to claim 2, wherein the processing circuitry is further configured to determine the provision destination candidate based on an input operation by the provider.

4. The biological information processing apparatus according to claim 2, wherein the processing circuitry is further configured to determine the provision destination candidate based on a type of the provision biological information.

5. The biological information processing apparatus according to claim 1, wherein the processing circuitry is further configured to acquire the value of the provision biological information based on a coincidence ratio between the provision biological information and the necessary information.

6. The biological information processing apparatus according to claim 1, wherein the processing circuitry is further configured to acquire a satisfaction level of the necessary information in the provision destination candidate, and
to acquire the value of the provision biological information further based on the acquired satisfaction level.

7. The biological information processing apparatus according to claim 1, wherein the processing circuitry is further configured to acquire information regarding importance of the necessary information, and
to acquire the value of the provision biological information further based on the acquired information regarding the importance.

8. The biological information processing apparatus according to claim 7, wherein the information regarding the importance includes information that performs weighting on biological information indicated in the necessary information.

9. The biological information processing apparatus according to claim 1, wherein the processing circuitry is further configured to present the acquired value of the provision biological information to the provider.

10. The biological information processing apparatus according to claim 9, wherein the processing circuitry is further configured to convert the acquired value of the provision biological information into an amount of money and to present the amount of money.

11. The biological information processing apparatus according to claim 1, wherein the processing circuitry is further configured to present, to the provider, provision related information regarding provision of the provision biological information to the provision destination candidate based on the acquired value of the provision biological information.

12. The biological information processing apparatus according to claim 11, wherein the processing circuitry is further configured to present possibility of provision of the provision biological information to the provision destination candidate as the provision related information.

13. The biological information processing apparatus according to claim 11, wherein the processing circuitry is further configured to present priority of provision of the provision biological information to each of a plurality of the provision destination candidates as the provision related information.

14. The biological information processing apparatus according to claim 1, wherein
the provision biological information includes a first item for classifying biological information and a value of the biological information belonging to the first item, and
the necessary information includes a second item for classifying the biological information.

15. The biological information processing apparatus according to claim 14, wherein the first item and the second item each include a detection time period of the biological information.

16. The biological information processing apparatus according to claim 14, wherein
the first item includes a medical insurance purchase status, and
the second item includes a value indicating presence or absence of medical insurance purchase.

17. The biological information processing apparatus according to claim 1, wherein the processing circuitry is further configured to support an application for medical cost deduction by the provider based on the acquired value of the provision biological information.

18. A biological information processing system comprising:
a first information processing apparatus of a provider of a provision biological information, the first information processing apparatus holding the provision biological information;
a second information processing apparatus of a provision destination candidate of the provision biological information, the second information processing apparatus holding necessary information indicating biological information required by the provision destination candidate; and
a biological information processing apparatus, wherein
the biological information processing apparatus comprises
processing circuitry configured to acquire the provision biological information from the first information processing apparatus and the necessary information from the second information processing apparatus, and
to acquire a value of the provision biological information based on the acquired provision biological information and the necessary information.

19. A biological information processing method comprising:
acquiring provision biological information held by a provider and necessary information indicating biological information required by a provision destination candidate of the provision biological information; and
acquiring a value of the provision biological information based on the acquired provision biological information and the necessary information.

20. A non-transitory computer-readable recording medium on which a biological information processing program is recorded, the biological information processing program causing a computer to execute:
acquiring provision biological information held by a provider and necessary information indicating biological information required by a provision destination candidate of the provision biological information; and
acquiring a value of the provision biological information based on the acquired provision biological information and the necessary information.
